(19) United States
(12) Patent Application Publication
(10) Pub. No.: US 2005/0087167 A1
(43) Pub. Date: Apr. 28, 2005

(54) Lower duct for a vehicle and manufacturing methods thereof

(76) Inventor: Jin Soo Kim, Jeonju-si (KR)

Correspondence Address: MORGAN, LEWIS & BOCKIUS LLP (SF), 2 PALO ALTO SQUARE, PALO ALTO, CA, 94306, US

(21) Appl. No.: 10/951,058

(22) Filed: Sep. 27, 2004

(30) Foreign Application Priority Data
Oct. 23, 2003 (KR) 2003-74406

(51) Int. Cl. F02B 77/00

(52) U.S. Cl. 123/198 E

(57) ABSTRACT

A method improves a lower duct structure which is capable of guiding air in a direction of an air cleaner in a large size truck. The mounting bracket inserted during a blow molding procedure of a lower duct is changed to a nut type. The nut type mounting bracket is directly inserted into a cavity of a mold, thus enhancing accuracy of a product. Assemblage work is also easily performed and an excellent assembling state is obtained after the assembling operation. Core mold work and the work process related with inserting the core mold are removed from the fabrication processes of the lower duct. Therefore, it is possible to significantly decrease the number of processes from the mold design to the fabrication of the product. Furthermore, the fabrication cost is reduced and the number of steps of work is decreased.

### CROSS REFERENCE TO RELATED APPLICATION(S)

This application is based on, and claims priority from Korean Application No. 2003-0074406, filed on Oct. 23, 2003, the disclosure of which is hereby incorporated by reference.

### TECHNICAL FIELD OF THE INVENTION

Generally, the present invention relates to a lower duct that guides air into an air cleaner in a vehicle and a manufacturing method thereof.

### BACKGROUND OF THE INVENTION

Typically, a duct system is employed in a large-sized vehicle, such as a truck, to supply air from the exterior of an engine room into an air cleaner of the engine. The duct system often includes an upper duct and a lower duct. The upper duct is exposed to the outside at an upper side of a truck cap. The lower duct, installed in an engine compartment of a vehicle, functions to guide external air in the direction of the air cleaner.

Such ducts are made of a plastic material by blow molding, wherein the lower duct is integrally formed with a mounting bracket for engagement with a frame of a vehicle. In particular, the lower duct is manufactured by the steps of designing a mold; designing a core; NC processing; mapping; inserting a core; inserting a mounting bracket; and blow molding.

In a conventional manufacturing of the lower duct, a core mold is inserted into the interior of a lower mold. A mounting bracket with a bolt is mounted onto the core mold and then a blow molding is performed, thereby, manufacturing the end product. However, the conventional manufacturing method is disadvantageous in that the thickness of the product adjacent to the mounting bracket is not uniform. Also, a resin is not uniformly filled in the portions near the mounting bracket, so that the overall quality of the product becomes inferior. Therefore, sometimes the center of the bolt does not coincide with the center of fixing holes formed in the frame during the assembling process thereof. Furthermore, at times, the engaging portions of the bolt may come off due to the unleveled surface of the product such that secure fixation of the element cannot be accomplished.

Still further, in the conventional manufacturing method of the lower duct, it is disadvantageous in that a core mold should be additionally provided. The core mold should be inserted into the mold during the blow molding process, whereby the manufacturing cost increases, and a desired workability is not achieved.

### SUMMARY OF THE INVENTION

It is an object of the present invention to provide a lower duct for a vehicle and a manufacturing method thereof, which is capable of improving the quality of the product and reducing labor-intensive processes by adopting a nut-type mounting bracket.

It is another object of the present invention to provide a lower duct of a vehicle and a manufacturing method thereof, which is capable of significantly reducing the number of processes involved in a core mold by excluding the use of core mold, whereby the cost for production and labor-intensive processes can be reduced.

To achieve these objects of the present invention, a manufacturing method for a lower duct according to the present invention, includes steps of directly inserting a nut-type mounting bracket into a cavity of a lower mold for blow molding without a core mold, and then injecting resin into the mold. Another embodiment of the manufacturing method includes a step of inserting a nut-type mounting bracket into a recess formed on the bottom surface of a lower mold.

Preferably, the nut-type mounting bracket has a plurality of fixing holes, into which resin flows, thus enhancing a cohesion between the lower duct and the mounting bracket. In a preferred embodiment, the fixing holes protrude upwardly, decreasing in diameter thereof, so that the bracket is not easily detached from the surface of the lower duct after the resin that flows into the fixing hole hardens. A preferred embodiment of the lower duct includes a nut-type bracket.

In another embodiment of the lower duct the nut-type bracket includes a nut disposed at the center thereof and a plurality of fixing holes penetrated by resin. The fixing holes are circularly located around the nut. In yet another embodiment the lower duct includes a plurality fixing holes formed on the nut-type bracket and protrude upwardly. The mounting bracket is preferably disposed at least four corners of the bottom surface of the lower duct.

### BRIEF DESCRIPTION OF THE DRAWINGS

The aforementioned aspects and other features of the present invention will be explained in the following detailed description, taken in conjunction with the accompanying drawings, wherein:

FIG. 1 is a cross sectional view illustrating a lower duct for blow molding and a mounting bracket according to an embodiment of the present invention;

FIG. 2 is a perspective view illustrating a mounting bracket according to an embodiment of the present invention;

FIG. 3 illustrates an upper mold for molding a lower duct according to an embodiment of the present invention;

FIG. 4 is another illustration of a lower mold for molding a lower duct according to an embodiment of the present invention;

FIG. 5 illustrates the top of the lower mold of FIG. 4;

FIG. 6 illustrates a bottom surface of a lower mold with a mounting bracket thereon according to an embodiment of the present invention; and

FIG. 7 shows a lower duct manufactured by a method according to an embodiment of the present invention.

### DETAILED DESCRIPTION OF PREFERRED EMBODIMENTS

According to an embodiment, the manufacturing method of a lower duct includes the steps of designing a mold, NC processing, mapping, fabricating a mounting bracket, assembling a mold, inserting a mounting bracket, and blow molding. The molding process is capable of removing a core design process and a core insert process as compared with a conventional manufacturing method. In particular, in the present invention, a nut-type mounting bracket is employed in the blow molding process, thus enhancing quality of a product after the blow molding is performed. As a result, the thickness of the surrounding portions, including a mounting bracket, after blow molding is uniform and substantially flat. Since the resin is uniformly filled in the surrounding portions of the mounting bracket, the accuracy of the product is also enhanced. It is possible to reduce the defects of a product based on the enhanced accuracy, and an engaging state is maintained after a certain period of time.

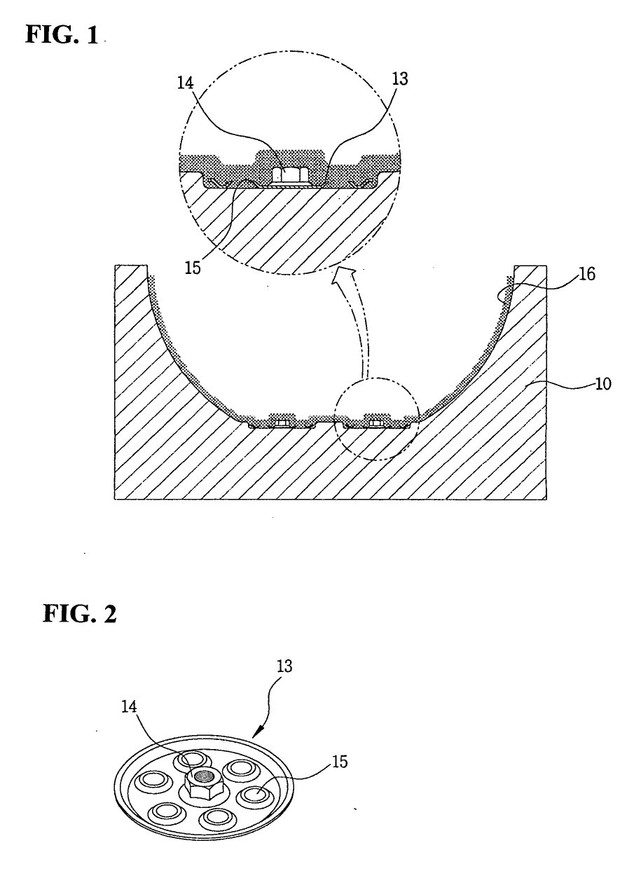

FIG. 1 shows a view of an insert state of a mounting bracket during a blow molding of a lower duct. A mounting bracket 13 having a nut 14 is directly inserted into the cavity of the lower mold 10 for a blow molding process. Since the mounting bracket 13 is formed as a nut type, a core mold is not necessary in the process. Because the mounting bracket 13 is engaged to a frame of a vehicle, it is preferable to use the mounting bracket made of steel in order to rigidly support a lower duct. In a preferred embodiment, a plurality of fixing holes 15 are formed in the mounting bracket 13 for enhancing an engaging force between the resin that forms the lower duct body 16 and the mounting bracket 13.

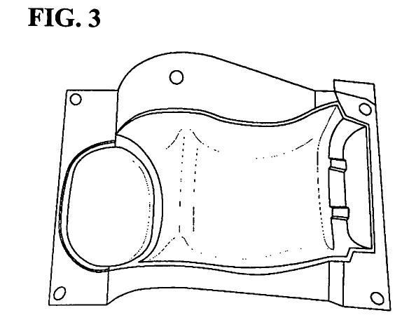

FIG. 2 illustrates a mounting bracket 13 wherein a nut 14 is welded to a center of a circular body and about six fixing holes 15 are formed around the nut 14. The mounting bracket is inserted into the bottom surface of the cavity of the lower mold 10, and melted resin is injected. When the resin is filled, a stable engaging force is obtained between the mounting bracket and the lower duct body. More preferably, the fixing hole is protruded upward, gradually decreasing the diameter thereof. The diameter of the hole at the bottom surface of the bracket is preferably greater than that of the hole at the distal end of the bracket, whereby the bracket and the body of the lower duct cannot be easily detached due to the shape of the bracket when the melted resin is solidified.

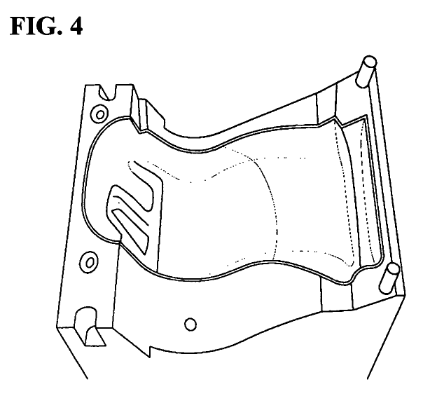

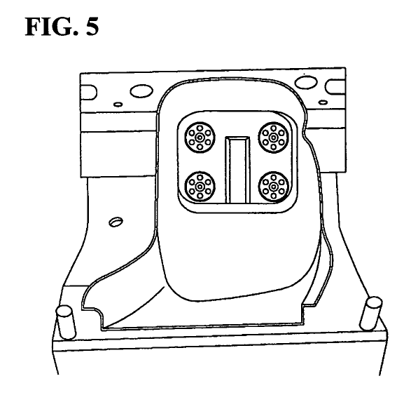

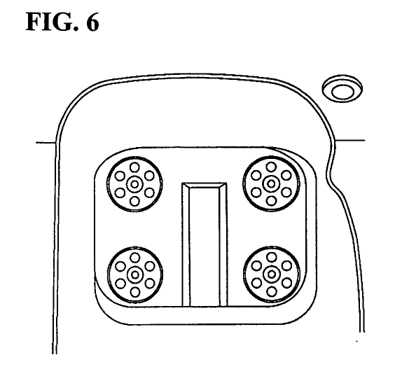

FIGS. 3-6 show a cavity structure of an upper mold and a lower mold for a lower duct molding. According to FIG. 3, the upper mold is assembled with the lower mold in which the mounting bracket is inserted. When the blow molding is performed, while injecting resin, after the upper and lower molds are assembled, a lower duct body with a cylindrical cross section is fabricated. As shown in FIGS. 4 and 5, the lower mold has a cavity structure capable of inserting the mounting bracket. Recesses are formed at four corners in the bottom surface of the cavity of the lower mold for inserting the mounting bracket and the blow molding is performed in a state that the mounting bracket is mounted on each recess.

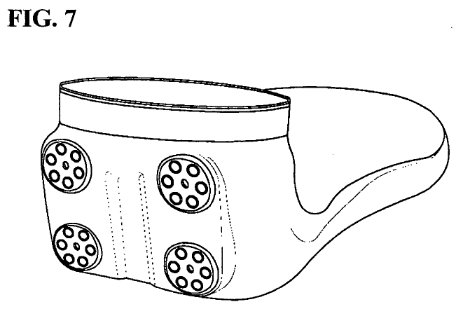

The mounting bracket, inserted into the recess in the cavity, is fully covered by resin injected into the interior of the cavity. As the resin flows into the fixing holes, the mounting bracket and the body of the lower duct are rigidly integrated. FIG. 7 shows a perspective view of the lower duct, showing a bottom surface of the lower duct where a frame of a vehicle is engaged. As shown therein, the resin fully covers the portions near the mounting bracket including the fixing hole, and it enables the mounting bracket to be integrally engaged with the lower duct body. In the assembling process of the lower duct to a frame of a vehicle, appropriate fasteners, such as bolts are utilized at the nut insertion portions of the mounting bracket.

1. A method for manufacturing a lower duct by a blow molding, comprising the steps of:
directly inserting a nut-type mounting bracket into a cavity of a lower mold for a blow molding without a core mold; and
injecting resin into the mold.

2. The method according to claim 1, wherein the nut-type mounting bracket is inserted into a recess formed on the bottom surface of the lower mold.

3. The method according to claim 1, wherein a plurality of fixing holes are formed in the mounting bracket, into which resin flows, thus enhancing an engaging force between the lower duct and the mounting bracket.

4. The method according to claim 2, wherein a plurality of fixing holes are formed in the mounting bracket, into which resin flows, thus enhancing an engaging force between the lower duct and the mounting bracket.

5. The method according to claim 3, wherein the fixing hole is protruded upward, gradually decreasing in diameter thereof, whereby the bracket and the body of the lower duct cannot be easily detached due to a shape of the bracket when the melted resin solidifies.

6. The method according to claim 4, wherein the fixing hole is protruded upward, gradually decreasing in diameter thereof, whereby the bracket and the body of the lower duct cannot be easily detached due to a shape of the bracket when the melted resin solidifies.

7. A lower duct for an automobile, comprising:
a lower duct configured and dimensioned to guide air into an air cleaner of a vehicle; and
a nut-type mounting bracket coupled with said lower duct.

8. The lower duct according to claim 7, wherein the mounting bracket comprises:
a nut at the center thereof; and
a plurality of fixing holes formed around the nut, into which resin flows.

9. The lower duct according to claim 8, wherein the fixing holes are protruded upwardly, gradually decreasing in diameter thereof.

10. The lower duct according to claim 7, wherein the mounting bracket is disposed at least four corners of the bottom surface of the lower duct.

11. The lower duct according to claim 8, wherein the mounting bracket is disposed at least four corners of the bottom surface of the lower duct.
